(19) United States
(12) Patent Application Publication
(10) Pub. No.: US 2010/0153390 A1
(43) Pub. Date: Jun. 17, 2010

(54) Scoring Deportment and Comportment Cohorts

(75) Inventors: Robert Lee Angell, Salt Lake City, UT (US); Robert R. Friedlander, Southbury, CT (US); James R. Kraemer, Santa Fe, NM (US)

Correspondence Address: Stewart & Liu PLLC, PO Box 797277, Dallas, TX, 75379, US

(73) Assignee: International Business Machines Corporation, Armonk, NY (US)

(21) Appl. No.: 12/336,440

(22) Filed: Dec. 16, 2008

(51) Int. Cl. G06F 17/30

(52) U.S. Cl. 707/736; 707/E17.001

(57) ABSTRACT

A computer implemented method, apparatus, and computer program product for scoring deportment and comportment cohorts. A deportment and comportment cohort having a set of conduct attributes is received. The conduct attributes may include at least one of a facial expression, vocalization, body language, and social interactions. A deportment and comportment cohort score is calculated. The deportment and comportment cohort score is normalized to calculate an overall deportment and comportment cohort score using at least one of demographic data and patterns of historical conduct. The overall cohort score indicates an appropriateness of conduct displayed by a member of the deportment and comportment cohort. Thereafter, a predefined action is executed based on the overall deportment and comportment cohort score.

### BACKGROUND OF THE INVENTION

1. Field of the Invention

The present invention relates generally to an improved data processing system and in particular to a method and apparatus for processing cohorts. More particularly, the present invention is directed to a computer implemented method, apparatus, and computer usable program code for scoring deportment and comportment cohorts.

2. Description of the Related Art

A cohort is a group of members selected based upon a commonality of one or more attributes. For example, one attribute may be a level of education attained by employees. Thus, a cohort of employees in an office building may include members who have graduated from an institution of higher education. In addition, the cohort of employees may include one or more sub-cohorts that may be identified based upon additional attributes such as, for example, a type of degree attained, a number of years the employee took to graduate, or any other conceivable attribute. In this example, such a cohort may be used by an employer to correlate an employee's level of education with job performance, intelligence, and/or any number of variables. The effectiveness of cohort studies depends upon a number of different factors, such as the length of time that the members are observed, and the ability to identify and capture relevant data for collection. For example, the information that is needed or wanted to identify attributes of potential members of a cohort may be voluminous, dynamically changing, unavailable, difficult to collect, and/or unknown to the members of the cohort and/or the user selecting members of the cohort. Moreover, it may be difficult, time consuming, or impractical to access all the information necessary to accurately generate cohorts. Thus, unique cohorts may be sub-optimal because individuals lack the skill, time, knowledge, and/or expertise needed to gather cohort attribute information from available sources.

### BRIEF SUMMARY OF THE INVENTION

According to one embodiment of the present inventions a computer implemented method, apparatus, and computer program product for scoring deportment and comportment cohorts is presented. A deportment and comportment cohort having a set of conduct attributes is received. The conduct attributes may include at least one of a facial expression, vocalization, body language, and social interactions. A deportment and comportment cohort score is calculated. The deportment and comportment cohort score is normalized to calculate an overall deportment and comportment cohort score using at least one of demographic data and patterns of historical conduct. The overall cohort score indicates an appropriateness of conduct displayed by a member of the deportment and comportment cohort. Thereafter, a predefined action is executed based on the overall deportment and comportment cohort score.

### BRIEF DESCRIPTION OF THE SEVERAL VIEWS OF THE DRAWINGS

FIG. 1 is a pictorial representation of a network of data processing systems in which illustrative embodiments may be implemented;

FIG. 2 is a block diagram of a data processing system in which illustrative embodiments may be implemented;

FIG. 3 is a block diagram of a conduct analysis system for scoring deportment and comportment cohorts in accordance with an illustrative embodiment;

FIG. 4 is a block diagram of a set of multimodal sensors in accordance with an illustrative embodiment;

FIG. 5 is a diagram of a set of cohorts used to generate a deportment and comportment cohort in accordance with an illustrative embodiment;

FIG. 6 is a block diagram of description data for an individual in accordance with an illustrative embodiment;

FIG. 7 is a block diagram of a conduct attribute calculation table in accordance with an illustrative embodiment;

FIG. 8 is a flowchart of a process for scoring a deportment and comportment cohort in accordance with an illustrative embodiment; and

FIG. 9 is a flowchart of a process for normalizing a deportment and comportment cohort in accordance with an illustrative embodiment.

### DETAILED DESCRIPTION OF THE INVENTION

As will be appreciated by one skilled in the art, the present invention may be embodied as a system, method or computer program product. Accordingly, the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the present invention may take the form of a computer program product embodied in any tangible medium of expression having computer usable program code embodied in the medium.

Any combination of one or more computer usable or computer readable medium(s) may be utilized. The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CDROM), an optical storage device, a transmission media such as those supporting the Internet or an intranet, or a magnetic storage device. Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory. In the context of this document, a computer-usable or computer-readable medium may be any medium that can contain, store, communicate, propagate, or transport the program for use by or in connection with the instruction execution system, apparatus, or device. The computer-usable medium may include a propagated data signal with the computer-usable program code embodied therewith, either in baseband or as part of a carrier wave. The computer usable program code may be transmitted using any appropriate medium, including but not limited to wireless, wire line, optical fiber cable, RF, etc.

Computer program code for carrying out operations of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The present invention is described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions.

These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer program instructions may also be stored in a computer-readable medium that can direct a computer or other programmable data processing apparatus to function in a particular manner, such that the instructions stored in the computer-readable medium produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide processes for implementing the functions/acts specified in the flowchart and/or block diagram block or blocks.

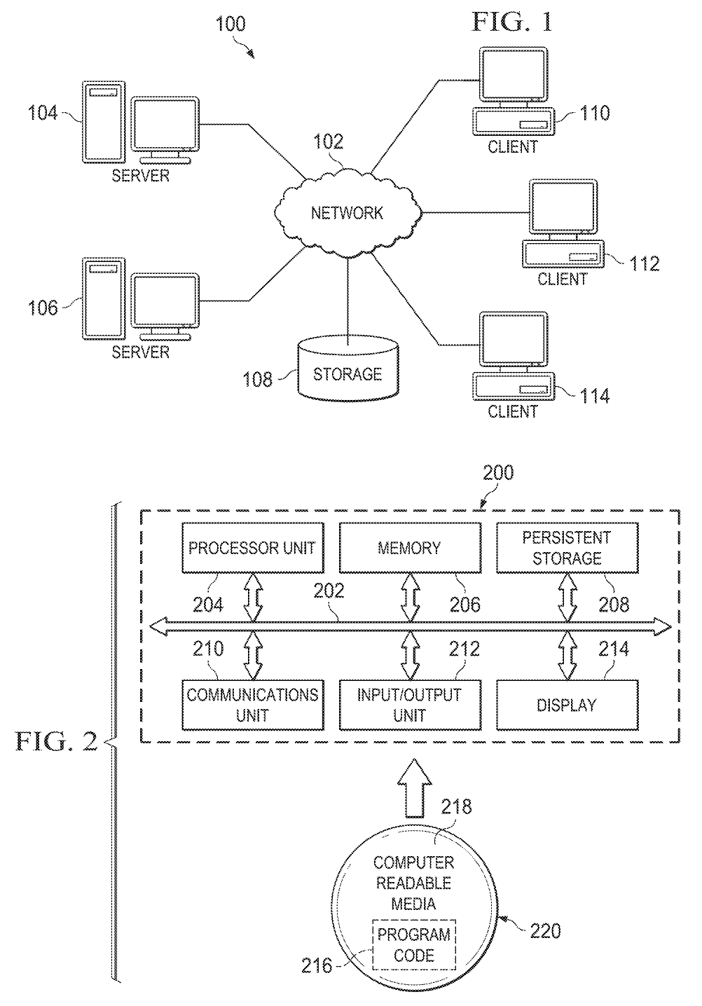

With reference now to the figures and in particular with reference to FIGS. 1-2, exemplary diagrams of data processing environments are provided in which illustrative embodiments may be implemented. It should be appreciated that FIGS. 1-2 are only exemplary and are not intended to assert or imply any limitation with regard to the environments in which different embodiments may be implemented. Many modifications to the depicted environments may be made.

FIG. 1 depicts a pictorial representation of a network of data processing systems in which illustrative embodiments may be implemented. Network data processing system 100 is a network of computers in which the illustrative embodiments may be implemented. Network data processing system 100 contains network 102, which is the medium used to provide communications links between various devices and computers connected together within network data processing system 100. Network 102 may include connections, such as wire, wireless communication links, or fiber optic cables.

In the depicted example, server 104 and server 106 connect to network 102 along with storage unit 108. In addition, clients 110, 112, and 114 connect to network 102. Clients 110, 112, and 114 may be, for example, personal computers or network computers. In the depicted example, server 104 provides data, such as boot files, operating system images, and applications to clients 110, 112, and 114. Clients 110, 112, and 114 are clients to server 104 in this example. Network data processing system 100 may include additional servers, clients, and other devices not shown.

Program code located in network data processing system 100 may be stored on a computer recordable storage medium and downloaded to a data processing system or other device for use. For example, program code may be stored on a computer recordable storage medium on server 104 and downloaded to client 110 over network 102 for use on client 110.

In the depicted example, network data processing system 100 is the Internet with network 102 representing a worldwide collection of networks and gateways that use the Transmission Control Protocol/Internet Protocol (TCP/IP) suite of protocols to communicate with one another. At the heart of the Internet is a backbone of high-speed data communication lines between major nodes or host computers, consisting of thousands of commercial, governmental, educational and other computer systems that route data and messages. Of course, network data processing system 100 also may be implemented as a number of different types of networks, such as for example, an intranet, a local area network (LAN), or a wide area network (WAN). FIG. 1 is intended as an example, and not as an architectural limitation for the different illustrative embodiments.

With reference now to FIG. 2, a block diagram of a data processing system is shown in which illustrative embodiments may be implemented. Data processing system 200 is an example of a computer, such as, without limitation, server 104 or client 110 in FIG. 1, in which computer usable program code or instructions implementing the processes may be located for the illustrative embodiments. In this illustrative example, data processing system 200 includes communications fabric 202, which provides communications between processor unit 204, memory 206, persistent storage 208, communications unit 210, input/output (I/O) unit 212, and display 214.

Processor unit 204 serves to execute instructions for software that may be loaded into memory 206. Processor unit 204 may be a set of one or more processors or may be a multi-processor core, depending on the particular implementation. Further, processor unit 204 may be implemented using one or more heterogeneous processor systems in which a main processor is present with secondary processors on a single chip. As another illustrative example, processor unit 204 may be a symmetric multi-processor system containing multiple processors of the same type.

Memory 206 and persistent storage 208 are examples of storage devices. A storage device is any piece of hardware that is capable of storing information either on a temporary basis and/or a permanent basis. Memory 206, in these examples, may be, for example, a random access memory or any other suitable volatile or non-volatile storage device. Persistent storage 208 may take various forms depending on the particular implementation. For example, persistent storage 208 may contain one or more components or devices. For example, persistent storage 208 may be a hard drive, a flash memory, a rewritable optical disk, a rewritable magnetic tape, or some combination of the above. The media used by persistent storage 208 also may be removable. For example, a removable hard drive may be used for persistent storage 208.

Communications unit 210, in these examples, provides for communications with other data processing systems or devices. In these examples, communications unit 210 is a network interface card. Communications unit 210 may provide communications through the use of either or both physical and wireless communications links.

Input/output unit 212 allows for input and output of data with other devices that may be connected to data processing system 200. For example, input/output unit 212 may provide a connection for user input through a keyboard and mouse. Further, input/output unit 212 may send output to a printer. Display 214 provides a mechanism to display information to a user.

Instructions for the operating system and applications or programs are located on persistent storage 208. These instructions may be loaded into memory 206 for execution by processor unit 204. The processes of the different embodiments may be performed by processor unit 204 using computer implemented instructions, which may be located in a memory, such as memory 206. These instructions are referred to as program code, computer usable program code, or computer readable program code that may be read and executed by a processor in processor unit 204. The program code in the different embodiments may be embodied on different physical or tangible computer readable media, such as memory 206 or persistent storage 208.

Program code 216 is located in a functional form on computer readable media 218 that is selectively removable and may be loaded onto or transferred to data processing system 200 for execution by processor unit 204. Program code 216 and computer readable media 218 form computer program product 220 in these examples. In one example, computer readable media 218 may be in a tangible form, such as, for example, an optical or magnetic disc that is inserted or placed into a drive or other device that is part of persistent storage 208 for transfer onto a storage device, such as a hard drive that is part of persistent storage 208. In a tangible form, computer readable media 218 also may take the form of a persistent storage, such as a hard drive, a thumb drive, or a flash memory that is connected to data processing system 200. The tangible form of computer readable media 218 is also referred to as computer recordable storage media. In some instances, computer recordable media 218 may not be removable.

Alternatively, program code 216 may be transferred to data processing system 200 from computer readable media 218 through a communications link to communications unit 210 and/or through a connection to input/output unit 212. The communications link and/or the connection may be physical or wireless in the illustrative examples. The computer readable media also may take the form of non-tangible media, such as communications links or wireless transmissions containing the program code.

In some illustrative embodiments, program code 216 may be downloaded over a network to persistent storage 208 from another device or data processing system for use within data processing system 200. For instance, program code stored in a computer readable storage medium in a server data processing system may be downloaded over a network from the server to data processing system 200. The data processing system providing program code 216 may be a server computer, a client computer, or some other device capable of storing and transmitting program code 216.

The different components illustrated for data processing system 200 are not meant to provide architectural limitations to the manner in which different embodiments may be implemented. The different illustrative embodiments may be implemented in a data processing system including components in addition to or in place of those illustrated for data processing system 200. Other components shown in FIG. 2 can be varied from the illustrative examples shown.

As one example, a storage device in data processing system 200 is any hardware apparatus that may store data. Memory 206, persistent storage 208, and computer readable media 218 are examples of storage devices in a tangible form.

In another example, a bus system may be used to implement communications fabric 202 and may be comprised of one or more buses, such as a system bus or input/output bus. Of course, the bus system may be implemented using any suitable type of architecture that provides for a transfer of data between different components or devices attached to the bus system. Additionally, a communications unit may include one or more devices used to transmit and receive data, such as a modem or a network adapter. A memory may be, for example, memory 206 or a cache such as found in an interface and memory controller hub that may be present in communications fabric 202.

The illustrative embodiments recognize that the ability to quickly and accurately perform an assessment of a person's conduct to identify the person's demeanor, manner, emotional state, and other features of the person's conduct in different situations and circumstances may be valuable to business planning, hiring employees, health, safety, marketing, transportation, and various other industries. Thus, according to one embodiment of the present invention, a computer implemented method, apparatus, and computer program product for analyzing sensory input data and cohort data associated with a set of individuals to generate deportment and comportment cohorts is provided.

According to one embodiment of the present invention, a computer implemented method, apparatus, and computer program product for scoring deportment and comportment cohorts. A deportment and comportment cohort having a set of conduct attributes is received. The conduct attributes may include at least one of a facial expression, vocalization, body language, and social interactions. A deportment and comportment cohort score is calculated. The deportment and comportment cohort score is normalized to calculate an overall deportment and comportment cohort score using at least one of demographic data and patterns of historical conduct. The overall cohort score indicates an appropriateness of conduct displayed by a member of the deportment and comportment cohort. Thereafter, a predefined action is executed based on the overall deportment and comportment cohort score.

A cohort is a group of people or objects. Members of a cohort share a common attribute or experience in common. A cohort may be a member of a larger cohort. Likewise, a cohort may include members that are themselves cohorts, also referred to as sub-cohorts. In other words, a first cohort may include a group of members that forms a sub-cohort. That sub-cohort may also include a group of members that forms a sub-sub-cohort of the first cohort, and so on. A cohort may be a null set with no members, a set with a single member, as well as a set of members with two or more members.

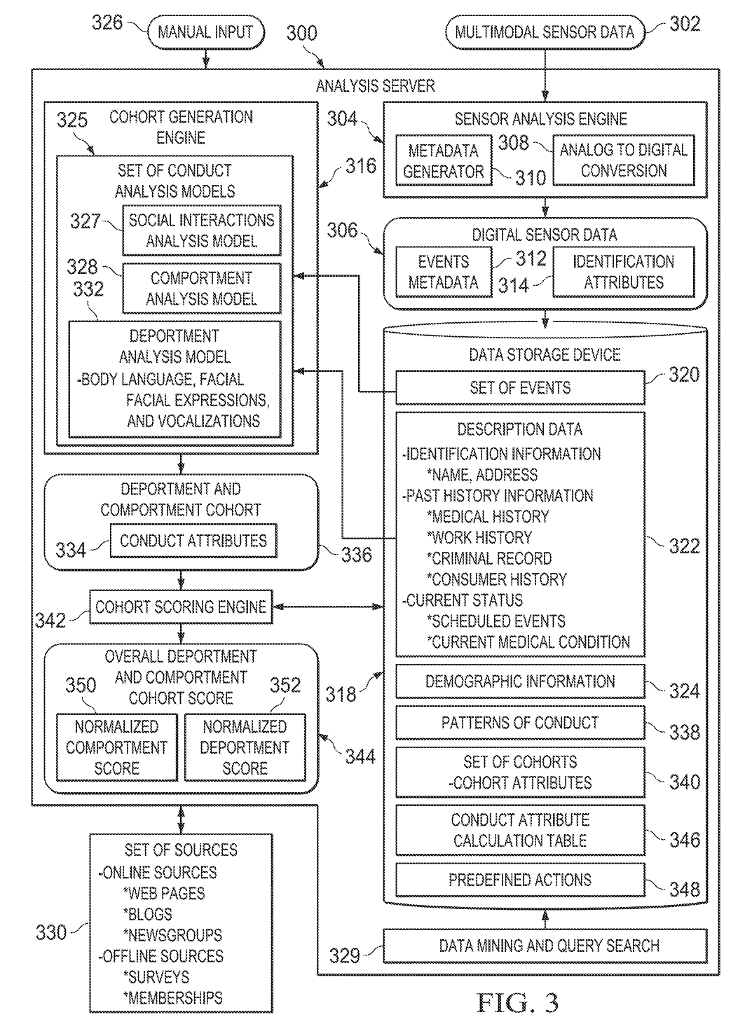

FIG. 3 is a block diagram of a conduct analysis system for generating deportment and comportment cohorts. Analysis server 300 is a server for analyzing sensor input associated with one or more individuals. Analysis server 300 may be implemented, without limitation, on a hardware computing device, such as, but not limited to, a main frame, server, a personal computer, laptop, personal digital assistant (PDA), or any other computing device depicted in FIGS. 1 and 2.

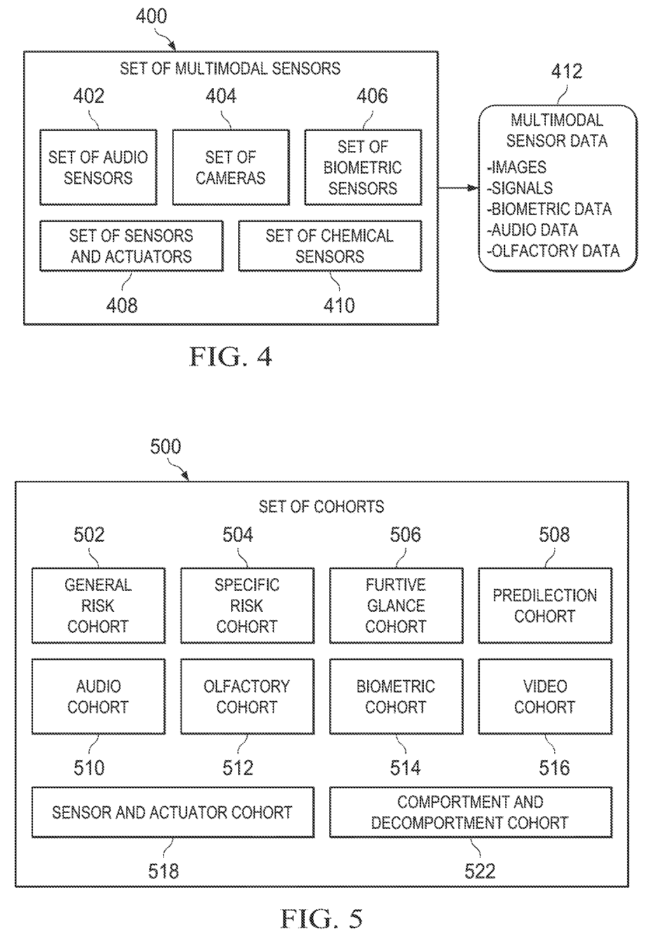

Analysis server 300 receives multimodal sensor data 302 from a set of multimodal sensors. Multimodal sensor data is data that is received from a multimodal sensor. A multimodal sensor may be a camera, an audio device, a biometric sensor, a chemical sensor, or a sensor and actuator, such as set of multimodal sensors in FIG. 4 below. Multimodal sensor data 302 is data that describes the set of individuals. In other words, multimodal sensors record readings for the set of individuals to form multimodal sensor data 302. For example, multimodal sensor data that is generated by a camera includes images of at least one individual in the set of individuals. As used herein, the term “at least one of”, when used with a list of items, means that different combinations of one or more of the items may be used and only one of each item in the list may be needed. For example, “at least one of item A, item B, and item C” may include, for example, without limitation, item A alone, item B alone, item C alone, a combination of item A and item B, a combination of item B and item C, a combination of item A and item C, or a combination that includes item A, item B, and item C.

Multimodal sensor data that is generated by a microphone includes audio data of sounds made by at least one individual in the set of individuals. Thus, multimodal sensor data 310 may include, without limitation, sensor input in the form of audio data, images from a camera, biometric data, signals from sensors and actuators, and/or olfactory patterns from an artificial nose or other chemical sensor.

Sensor analysis engine 304 is software architecture for analyzing multimodal sensor data 302 to generate digital sensor data 306. Analog to digital conversion 308 is a software component that converts any multimodal sensor data that is in an analog format into a digital format. Analog to digital conversion 308 may be implemented using any known or available analog to digital converter (ADC). Sensor analysis engine 304 processes and parses the sensor data in the digital format to identify attributes of the set of individuals. Metadata generator 310 is a software component for generating metadata describing the identified attributes of the set of individuals.

Sensor analysis engine 304 may include a variety of software tools for processing and analyzing the different types of sensor data in multimodal sensor data 302. Sensor analysis engine 304 may include, without limitation, olfactory analytics for analyzing olfactory sensory data received from chemical sensors, video analytics for analyzing images received from cameras, audio analytics for analyzing audio data received from audio sensors, biometric data analytics for analyzing biometric sensor data from biometric sensors, and sensor and actuator signal analytics for analyzing sensor input data from sensors and actuators.

Sensor analysis engine 304 may be implemented using a variety of digital sensor analysis technologies, such as, without limitation, video image analysis technology, facial recognition technology, license plate recognition technology, and sound analysis technology. In one embodiment, sensor analysis engine 304 is implemented using, without limitation, IBM® smart surveillance system (S3) software.

Sensor analysis engine 304 utilizes computer vision and pattern recognition technologies, as well as video analytics to analyze video images captured by one or more situated cameras, microphones, or other multimodal sensors. The analysis of multimodal sensor data 302 generates events metadata 312 describing events of interest in the environment. Events metadata 312 is data that describes a set of circumstances associated with selected individuals, such as the set of members of a deportment and comportment cohort.

Sensor analysis engine 304 includes video analytics software for analyzing video images and audio files generated by the multimodal sensors. The video analytics may include, without limitation, behavior analysis, license plate recognition, face recognition, badge reader, and radar analytics technology. Behavior analysis technology tracks moving objects and classifies the objects into a number of predefined categories by analyzing metadata describing images captured by the cameras. As used herein, an object may be a human, an object, a container, a cart, a bicycle, a motorcycle, a car, a location, or an animal, such as, without limitation, a dog. License plate recognition technology may be utilized to analyze images captured by cameras deployed at the entrance to a facility, in a parking lot, on the side of a roadway or freeway, or at an intersection. License plate recognition technology catalogs a license plate of each vehicle moving within a range of two or more video cameras associated with sensor analysis engine 304. For example, license plate recognition technology may be utilized to identify a license plate number on license plate.

Face recognition technology is software for identifying a human based on an analysis of one or more images of the human's face. Face recognition technology may be utilized to analyze images of objects captured by cameras deployed at entryways, or any other location, to capture and recognize faces. Badge reader technology may be employed to read badges. The information associated with an object obtained from the badges is used in addition to video data associated with the object to identify an object and/or a direction, velocity, and/or acceleration of the object.

The data gathered from behavior analysis technology, license plate recognition technology, facial recognition technology, badge reader technology, radar analytics technology, and any other video/audio data received from a camera or other video/audio capture device is received by sensor analysis engine 304 for processing into events metadata 312 describing events and/or identification attributes 314 of one or more objects in a given area. The events from all these technologies are cross indexed into a common repository or a multi-mode event database allowing for correlation across multiple audio/video capture devices and event types. In such a repository, a simple time range query across the modalities will extract license plate information, vehicle appearance information, badge information, object location information, object position information, vehicle make, model, year and/or color, and face appearance information. This permits sensor analysis engine 304 to easily correlate these attributes.

Digital sensor data 306 comprises events metadata 312 describing set of events 320 associated with an individual in the set of individuals. An event is an action or event that is performed by the individual or in proximity to the individual. An event may be the individual making a sound, walking, eating, making a facial expression, a change in the individual's posture, spoken words, the individual throwing an object, talking to someone, carrying a child, holding hands with someone, picking up an object, standing still, or any other movement, conduct, or event.

Digital sensor data 306 may also optionally include identification attributes 314. An attribute is a characteristic, feature, or property of an object. Identification attribute 314 is an attribute that may be used to identify a person. In a non-limiting example, identification attribute may include a person's name, address, eye color, age, voice pattern, the color of their jacket, the size of their shoes, retinal pattern, iris pattern, fingerprint, thumbprint, palm print, facial recognition data, badge reader data, smart card data, scent recognition data, license plate number, and so forth. Attributes of a thing may include the name of the thing, the value of the thing, whether the thing is moving or stationary, the size, height, volume, weight, color, or location of the thing, and any other property or characteristic of the thing.

Cohort generation engine 316 receives digital sensor data 308 from sensor analysis engine 304. Cohort generation engine 316 may request digital sensor data 306 from sensor analysis engine 304 or retrieve digital sensor data 308 from data storage device 318. In another embodiment, sensor analysis engine 304 automatically sends digital sensor data 308 to cohort generation engine 316 in real time as digital sensor data 308 is generated. In yet another embodiment, sensor analysis engine 304 sends digital sensor data 308 to cohort generation engine 316 upon the occurrence of a predetermined event. A predetermined event may be, but is not limited to, a given time, completion of processing multimodal sensor data 302, occurrence of a timeout event, a user request for generation of set of cohorts based on digital sensor data 308, or any other predetermined event. The illustrative embodiments may utilize digital sensor data 308 in real time as digital sensor data 308 is generated or utilize digital sensor data 308 that is pre-generated or stored in data storage device 318 until the digital sensor data is retrieved at some later time.

Data storage device 318 may be a local data storage located on the same computing device as cohort generation engine 316. In another embodiment, data storage device 318 is located on a remote data storage device that is accessed through a network connection. In yet another embodiment, data storage device 318 may be implemented using two or more data storage devices that may be either local or remote data storage devices.

Cohort generation engine 316 retrieves any description data 322 for the individual that is available. Description data 322 may include identification information identifying the individual, past history information for the individual, and/or current status information for the individual. Information identifying the individual may be a person's name, address, age, birth date, social security number, employee identification number, or any other identification information. Past history information is any information describing past events associated with the individual. Past history information may include medical history, work history/employment history, social security records, criminal record, consumer history, educational history, previous residences, prior owned property, repair history of property owned by the individual, or any other past history information. For example, education history may include, without limitation, schools attended, degrees obtained, grades earned, and so forth. Medical history may include previous medical conditions, previous medications prescribed to the individual, previous physicians that treated the individual, medical procedures/surgeries performed on the individual, and any other past medical information.

Current status information is any information describing a current status of the individual. Current status information may include, for example and without limitation, scheduled events, current medical condition, current prescribed medications, current status of the individual's driver's license, current residence, marital status, and any other current status information.

Cohort generation engine 316 optionally retrieves demographic information 324 from data storage device 318. Demographic information 324 describes demographic data for the individual's demographic group. Demographic information 324 may be obtained from any source that compiles and distributes demographic information.

In another embodiment, cohort generation engine 316 receives manual input 326 that provides manual input describing the individual and/or manual input defining the analysis of events metadata 312 and/or identification attributes 314 for the individual.

In another embodiment, if description data 322 is not available, data mining and query search 329 searches set of sources 330 to identify additional description data for the individual. Set of sources 330 may include online sources, as well as offline sources. Online sources may be, without limitation, web pages, blogs, wikis, newsgroups, social networking sites, forums, online databases, and any other information available on the Internet. Off-line sources may include, without limitation, relational databases, data storage devices, or any other off-line source of information.

Cohort generation engine 316 selects a set of conduct analysis models for use in processing set of events 320, identification attributes 314, description data 322, demographic data 324, and/or manual input 326. Cohort generation engine 316 selects the conduct analysis models based on the type of event metadata and the available description data to form set of conduct analysis models 325. In this example, conduct analysis models may include, without limitation, social interaction analysis model 327, comportment analysis model 328, and deportment analysis model 332.

Deportment analysis model 332 may utilize facial expression analytics to analyze images of an individual's face and generates conduct attributes 334 describing the individual's emotional state based on their expressions. For example, if a person is frowning and their brow is furrowed, deportment analysis models 325 may infer that the person is angry or annoyed. If the person is pressing their lips together and shuffling their feet, the person may be feeling uncertain or pensive. These emotions are identified in conduct attributes 334. Deportment analysis model 332 analyzes body language that is visible in images of a person's body motions and movements, as well as other attributes indicating movements of the person's feet, hands, posture, hands, and arms to identify conduct attributes describing the person's manner, attitude, and conduct. Deportment analysis model 332 utilizes vocalization analytics to analyze set of events 320 and identification attributes 314 to identify sounds made by the individual and words spoken by the individual. Vocalizations may include, words spoken, volume of sounds, and non-verbal sounds.

Comportment analysis model 328 analyzes set of events 320 to identify conduct attributes 334 indicating an overall level of refinement in movements and overall smooth conduct and successful completion of tasks without hesitancy, accident, or mistakes. The term comportment refers to how refined or unrefined the person's overall manner appears. Comportment analysis model 328 attempts to determine whether the persons overall behavior is refined, smooth, confident, rough, uncertain, hesitant, unrefined, or otherwise how well the person is able to complete tasks.

The term social interactions refers to social manner, interactions with others, and the manner in which the person interacts with other people and with animals. Social interaction analysis model 327 analyzes set of events 320 described in events metadata to identify conduct attributes indicating types social interactions engaged in by the individual and a level of appropriateness of the social interactions. The type of social interactions comprises identifying interactions of an individual as the interactions typical of a leader, a follower, a loner, an introvert, an extrovert, a charismatic person, an emotional person, a calm person, a person acting spontaneously, or a person acting according to a plan

Cohort generation engine 316 selects analysis models for set of conduct analysis models 325 based on the type of events in set of events and the type of description data available. For example, a teller at a bank assisting customers may exhibit conduct attributes that may have a comportment component and a deportment component. Cohort generation engine 316 may select deportment analysis model 332 for processing set of events 320 to identify conduct attributes for inclusion in conduct attributes 334 which are associated with the teller's emotional state as is evidenced by expressions or actions. Similarly, cohort generation engine 316 may select comportment analysis model 332 for processing set of events 320 to identify conduct attributes for inclusion in conduct attributes 334 which are associated with the overall refinement of the teller's mannerisms.

Cohort generation engine 316 analyzes events metadata 312 describing set of events 320 and identification attributes 314 with any demographic information 324, description data 322, and/or user input 326 in the selected set of conduct analysis models 325 to form deportment and comportment cohort 336. Deportment and comportment cohort 336 may include a deportment cohort and/or a comportment cohort. Deportment refers to the way a person behaves toward other people, demeanor, conduct, behavior, manners, social deportment, citizenship, swashbuckling, correctitude, properness, propriety, improperness, impropriety, and personal manner. Swashbuckling refers to flamboyant, reckless, or boastful behavior. The deportment cohort may identify conduct attributes 334 indicating the type of demeanor, manner, or conduct being displaying.

The term comportment refers to how refined or unrefined the person's overall manner appears. The comportment cohort may include conduct attributes 334 identifying whether the persons overall behavior is refined, smooth, or confident. The comportment cohort may also indicate if the person's overall behavior is rough, uncertain, hesitant, unrefined, or otherwise how well the person is able to complete tasks.

In another embodiment, cohort generation engine 316 compares conduct attributes 334 to patterns of conduct 338 to identify additional members of deportment and comportment cohort 336. Patterns of conduct 338 are known patterns of conduct that indicate a particular demeanor, attitude, emotional state, or manner of a person. Each different type of conduct by an individual in different environments results in different sensor data patterns and different attributes. When a match is found between known patterns of conduct 338 and some of conduct attributes 334, the matching pattern may be used to identify attributes and conduct of the individual.

In yet another embodiment, cohort generation engine 316 also retrieves set of cohorts 340. Set of cohorts 340 is a set of one or more cohorts associated with the individual. Set of cohorts 340 may include an audio cohort, a video cohort, a biometric cohort, a furtive glance cohort, a sensor and actuator cohort, specific risk cohort, a general risk cohort, a predilection cohort, and/or an olfactory cohort. Cohort generation engine 316 optionally analyzes cohort data and attributes of cohorts in set of cohorts 340 with set of events 320, description data 322, and identification attributes 314 in set of conduct analysis models 325 to generate deportment and comportment cohort 336.

In response to new digital sensor data being generated by sensor analysis engine 304, cohort generation engine 316 analyzes the new digital sensor data in set of conduct analysis models 325 to generate an updated set of events and an updated deportment and comportment cohort.

Cohort scoring engine 342 receives deportment and comportment 336 for further processing. In particular, cohort scoring engine 342 is a software component for calculating overall deportment and comportment cohort score 344 based upon factors such as, for example, a location in which conduct attributes are exhibited, the actors involved in the display of conduct attributes, or the existence of expected conduct attributes based upon demographics data or patterns of historical conduct.

Overall deportment and comportment cohort score 344 is a value that indicates the appropriateness of conduct attributes displayed by members of deportment and comportment cohort 336. For example, a member of a deportment and comportment cohort may exhibit or possess conduct attributes showing the cohort member loitering around at particular location. The appropriateness of such conduct may be based upon circumstances and/or patterns of historical conduct. For example, those conduct attributes may be appropriate if the cohort member is located at a bus stop in the winter. However, those conduct attributes may be inappropriate for a cohort member located in a parking lot of a bank in the middle of the summer, except if such behavior is common for that cohort member. For instance, the cohort member may be a bank employee on a smoke break. In addition, the cohort member may have a medical condition requiring the cohort member to wear an overcoat to block out exposure to the sun. Thus, the appropriateness of conduct attributes may be determined based upon circumstances or patterns of historical conduct. The patterns of historical conduct may be derived or identified from patterns of conduct 338.

In addition, the appropriateness of conduct attributes may be determined based upon an existence of expected conduct attributes in demographic information 324. For example, demographic information 324 may specify that children are more likely to exhibit emotional outbursts that include yelling in a retail facility. Thus, yelling by children in a convenience store may be an expected conduct attribute. Similarly, demographic information 324 may include a profile for individuals with medical conditions that cause uncontrollable, non-violent vocal outbursts. Thus, conduct attributes that describe vocal outbursts exhibited by children or other cohort members with medical conditions would not be unexpected.

The appropriateness of conduct attributes exhibited by members of deportment and comportment cohort 336 are accounted for by the overall deportment and comportment cohort score 344. In a non-limiting example, the appropriateness of conduct attributes is a characteristic that identifies conduct attributes as expected or unexpected. Expected conduct attributes are attributes which may be explicitly identified in demographic information 324 or found in patterns of conduct 324. Alternatively, appropriateness may be determined by statistical analysis. For example, if a threshold percentage of all people assigned to a deportment and comportment cohort exhibit a certain type of conduct attribute, then the conduct attribute may be identified as appropriate or expected. Alternatively if a threshold percentage of people do not exhibit a conduct attribute, then the conduct attribute may be identified as inappropriate or unexpected.

Cohort scoring engine 342 calculates overall deportment and comportment cohort score 340 using conduct attribute calculation table 346. Conduct attribute calculation table 346 is a data structure storing entries that associates conduct attributes with a scoring value and optionally a weighting factor. Cohort scoring engine 342 may locate a conduct attribute exhibited by members of deportment and comportment cohort 336 and aggregate the associated scoring values. Thereafter, the aggregated scoring value may be normalized with weighting factors to take into consideration other circumstances, such as, for example, a location in which the conduct attribute is exhibited, the actor exhibiting the conduct attribute, factors that may have provoked the actor, patterns of historical conduct or expected behavior based upon demographic information.

For example, conduct attribute calculation table 346 may include one entry for a conduct attribute for furtive glance behavior. Furtive glance behavior may include, for example, conduct attributes such as rapid eye movement, viewing a threshold number of objects in a predefined period of time, sweating, clenching of teeth, or any other conduct attribute that has been previously associated with furtive glance behavior. An initial scoring value may be assigned to the deportment and comportment cohort based on the conduct attributes for furtive glance behavior. The scoring value may be normalized based on circumstances. For example, furtive glance behavior exhibited in a bank may be weighted to indicate that such behavior is less expected. Consequently, the weight factor applied to the conduct attributes for furtive glance behavior may reflect the inappropriateness of the associated furtive glance conduct attributes. However, furtive glance behavior exhibited in by a stockbroker on a trading floor may be expected. Consequently, weighting factors, if applied, may indicate that furtive glance conduct attributes are not unexpected.

Cohort scoring engine 342 may also execute a predefined action in response to calculating overall deportment and comportment cohort score 344. For example, after calculating overall deportment and comportment cohort score 344, cohort scoring engine 342 may reference predefined actions 348 for determining whether to execute a predefined action. Predefined actions 348 is a data structure storing a list of predefined actions and associated threshold values. Thus, if the threshold value is met or exceed, then the associated predefined action may be taken. The predefined action may include, for example and without limitation, at least one of sending a warning, generating an alert, and dispatching security personnel.

In an alternate embodiment, during the calculation of overall deportment and comportment cohort score 344, cohort scoring engine 342 calculates and maintains separate scores for the deportment component and comportment components of overall deportment and comportment cohort score 344. Thus, overall deportment and comportment cohort score may include normalized comportment score 350 and normalized deportment score 352.

Normalized comportment score 350 is a scoring component of overall deportment and comportment cohort score 344 that is calculated based upon conduct attributes from conduct attributes 334 that is associated with a comportment aspects of a cohort member's behavior. Normalized deportment score 352 is a scoring component of overall deportment and comportment cohort score 344 that is calculated based upon conduct attributes from conduct attributes 334 that is associated with deportment aspects of behavior. In this embodiment, the aggregate values of normalized comportment score 350 and normalized deportment score 352 form overall deportment and comportment cohort score 344. The overall deportment and comportment cohort score 344 may used for identifying predefined actions 348 for execution.

The individual components scores forming overall deportment and comportment cohort score 344 may be used for identifying predefined actions 348 for execution. For example, predefined actions 348 may include ranges of specified comportment scores and ranges of specified deportment scores. Thus, if normalized comportment score 350 or normalized deportment score 352 is outside a range of specified comportment scores or deportment scores, respectively, then cohort scoring engine 342 may still execute a predefined action even though overall deportment and comportment cohort score 344 may be below an actionable threshold.

Analysis server 300 continues to analyze new conduct attributes 334 for deportment and comportment cohort 336 and generates updated overall deportment and comportment cohort scores as conduct attributes 334 change. In this manner, cohort scoring engine 336 can generate a series of overall deportment and comportment cohort scores over a given period of time and alert a user or take an action when the overall deportment and comportment cohort sore score indicates certain behavior, as evidenced by conduct attributes 334, may require action.

After generating overall deportment and comportment cohort score 344, cohort scoring engine 342 may update demographics information 324 and/or patterns of conduct 338. The updating of demographics information 324 and/or patterns of conduct 338 insures that the evolving habits of cohort members are properly weighted. For example, demographics information 324 may change to indicate that, with increasingly sedentary lifestyles, a particular demographic may be more prone to sweating with less exertion than the same demographic a decade ago. Thus, an increased likelihood for sweating may warrant the application of a weighting factor to indicate that such a conduct attribute is more expected or appropriate.

Referring now to FIG. 4, a block diagram of a set of multimodal sensors is depicted in accordance with an illustrative embodiment. Set of multimodal sensors 400 is a set of sensors that gather sensor data associated with a set of individuals. In this non-limiting example, set of multimodal sensors 400 includes set of audio sensors 402, set of cameras 404, set of biometric sensors 406, set of sensors and actuators 408, set of chemical sensors 410, and any other types of devices for gathering data associated with a set of objects and transmitting that data to an analysis engine, such as sensor analysis engine 304. Set of multimodal sensors 400 detect, capture, and/or record multimodal sensor data 412.

Set of audio sensors 402 is a set of audio input devices that detect, capture, and/or record vibrations, such as, without limitation, pressure waves, and sound waves. Vibrations may be detected as the vibrations are transmitted through any medium, such as, a solid object, a liquid, a semisolid, or a gas, such as the air or atmosphere. Set of audio sensors 402 may include only a single audio input device, as well as two or more audio input devices. An audio sensor in set of audio sensors 402 may be implemented as any type of device that can detect vibrations transmitted through a medium, such as, without limitation, a microphone, a sonar device, an acoustic identification system, or any other device capable of detecting vibrations transmitted through a medium.

Set of cameras 404 may be implemented as any type of known or available camera(s). A cameral may be, without limitation, a video camera for generating moving video images, a digital camera capable of taking still pictures and/or a continuous video stream, a stereo camera, a web camera, and/or any other imaging device capable of capturing a view of whatever appears within the camera's range for remote monitoring, viewing, or recording of an object or area. Various lenses, filters, and other optical devices such as zoom lenses, wide-angle lenses, mirrors, prisms, and the like, may also be used with set of cameras 404 to assist in capturing the desired view. A camera may be fixed in a particular orientation and configuration, or it may, along with any optical devices, be programmable in orientation, light sensitivity level, focus or other parameters.

Set of cameras 404 may be implemented as a stationary camera and/or non-stationary camera. A stationary camera is in a fixed location. A non-stationary camera may be capable of moving from one location to another location. Stationary and non-stationary cameras may be capable of tilting up, down, left, and right, panning, and/or rotating about an axis of rotation to follow or track an object in motion or keep the object, within a viewing range of the camera lens. The image and/or audio data in multimodal sensor data 412 that is generated by set of cameras 404 may be a sound file, a media file, a moving video file, a still picture, a set of still pictures, or any other form of image data and/or audio data. Video and/or audio data 404 may include, for example and without limitation, images of a person's face, an image of a part or portion of a customer's car, an image of a license plate on a car, and/or one or more images showing a person's behavior. In a non-limiting example, an image showing a customer's behavior or appearance may show a customer wearing a long coat on a hot day, a customer walking with two small children, a customer moving in a hurried or leisurely manner, or any other type behavior of one or more objects.

Set of biometric sensors 406 is a set of one or more devices for gathering biometric data associated with a human or an animal. Biometric data is data describing a physiological state, physical attribute, or measurement of a physiological condition. Biometric data may include, without limitation, fingerprints, thumbprints, palm prints, footprints, hear rate, retinal patterns, iris patterns, pupil dilation, blood pressure, respiratory rate, body temperature, blood sugar levels, and any other physiological data. Set of biometric sensors 406 may include, without limitation, fingerprint scanners, palm scanners, thumb print scanners, retinal scanners, iris scanners, wireless blood pressure monitor, heart monitor, thermometer or other body temperature measurement device, blood sugar monitor, microphone capable of detecting heart beats and/or breath sounds, a breathalyzer, or any other type of biometric device.

Set of sensors and actuators 408 is a set of devices for detecting and receiving signals from devices transmitting signals associated with the set of objects. Set of sensors and actuators 408 may include, without limitation, radio frequency identification (RFID) tag readers, global positioning system (GPS) receivers, identification code readers, network devices, and proximity card readers. A network device is a wireless transmission device that may include a wireless personal area network (PAN), a wireless network connection, a radio transmitter, a cellular telephone, Wi-Fi technology, Bluetooth technology, or any other wired or wireless device for transmitting and receiving data. An identification code reader may be, without limitation, a bar code reader, a dot code reader, a universal product code (UPC) reader, an optical character recognition (OCR) text reader, or any other type of identification code reader. A GPS receiver may be located in an object, such as a car, a portable navigation system, a personal digital assistant (PDA), a cellular telephone, or any other type of object.

Set of chemical sensors 410 may be implemented as any type of known or available device that can detect airborne chemicals and/or airborne odor causing elements, molecules, gases, compounds, and/or combinations of molecules, elements, gases, and/or compounds in an air sample, such as, without limitation, an airborne chemical sensor, a gas detector, and/or an electronic nose. In one embodiment, set of chemical sensors 410 is implemented as an array of electronic olfactory sensors and a pattern recognition system that detects and recognizes odors and identifies olfactory patterns associated with different odor causing particles. The array of electronic olfactory sensors may include, without limitation, metal oxide semiconductors (MOS), conducting polymers (CP), quartz crystal microbalance, surface acoustic wave (SAW), and field effect transistors (MOSFET). The particles detected by set of chemical sensors may include, without limitation, atoms, molecules, elements, gases, compounds, or any type of airborne odor causing matter. Set of chemical sensors 410 detects the particles in the air sample and generates olfactory pattern data in multimodal sensor data 412.

Multimodal sensor data 412 may be in an analog format, in a digital format, or some of the multimodal sensor data may be in analog format while other multimodal sensor data may be in digital format.

FIG. 5 is a block diagram of a set of cohorts used to generate a deportment and comportment cohort in accordance with an illustrative embodiment. Set of cohorts 500 is a set of one or more cohorts associated with a set of individuals, such as set of cohorts 340 in FIG. 3. General risk cohort 502 is a cohort having members that are general or generic rather than specific. Each member of general risk cohort 502 comprises data describing objects belonging to a category. A category refers to a class, group, category, or kind. A member of a general cohort is a category or sub-cohort including general or average and the risks associated with those members. Specific risk cohort 504 is a cohort having members that are specific, identifiable individuals and the risks associated with the members of the cohort. Furtive glance cohort 506 is a cohort comprising attributes describing eye movements by members of the cohort. The furtive glance attributes describe eye movements, such as, but without limitation, furtive, rapidly shifting eye movements, rapid blinking, fixed stare, failure to blink, rate of blinking, length of a fixed stare, pupil dilations, or other eye movements.

A predilection is the tendency or inclination to take an action or refrain from taking an action. Predilection cohort 508 comprises attributes indicating whether an identified person will engage in or perform a particular action given a particular set of circumstances. Audio cohort 510 is a cohort comprising a set of members associated with attributes identifying a sound, a type of sound, a source or origin of a sound, identifying an object generating a sound, identifying a combination of sounds, identifying a combination of objects generating a sound or a combination of sounds, a volume of a sound, and sound wave properties.

Olfactory cohort 512 is a cohort comprising a set of members associated with attributes of a chemical composition of gases and/or compounds in the air sample, a rate of change of the chemical composition of the air sample over time, an origin of gases in the air sample, an identification of gases in the air sample, an identification of odor causing compounds in the air sample, an identification of elements or constituent gases in the air sample, an identification of chemical properties and/or chemical reactivity of elements and/or compounds in the air sample, or any other attributes of particles into the air sample.

Biometric cohort 514 is a set of members that share at least one biometric attribute in common. A biometric attribute is an attribute describing a physiologic change or physiologic attribute of a person, such as, without limitation, heart rate, blood pressure, finger print, thumb print, palm print, retinal pattern, iris pattern, blood type, respiratory rate, blood sugar level, body temperature, or any other biometric data.

Video cohort 516 is a cohort having a set of members associated with video attributes. Video attributes may include, without limitation, a description of a person's face, color of an object, texture of a surface of an object, size, height, weight, volume, shape, length, width, or any other visible features of the cohort member.

Sensor and actuator cohort 518 includes a set of members associated with attributes describing signals received from sensors or actuators. An actuator is a device for moving or controlling a mechanism. A sensor is a device that gathers information describing a condition, such as, without limitation, temperature, pressure, speed, position, and/or other data. A sensor and/or actuator may include, without limitation, a bar code reader, an electronic product code reader, a radio frequency identification (RFID) reader, oxygen sensors, temperature sensors, pressure sensors, a global positioning system (GPS) receiver, also referred to as a global navigation satellite system receiver, Bluetooth, wireless blood pressure monitor, personal digital assistant (PDA), a cellular telephone, or any other type of sensor or actuator.

Deportment and comportment cohort 522 is a cohort having members associated with attributes identifying a demeanor and manner of the members. Deportment and comportment cohort 522 may include attributes identifying the way a person behaves toward other people, demeanor, conduct, behavior, manners, social deportment, citizenship, swashbuckling, correctitude, properness, propriety, improperness, impropriety, and personal manner. Swashbuckling refers to flamboyant, reckless, or boastful behavior. Deportment and comportment cohort 522 may include attributes identifying how refined or unrefined the person's overall manner appears.

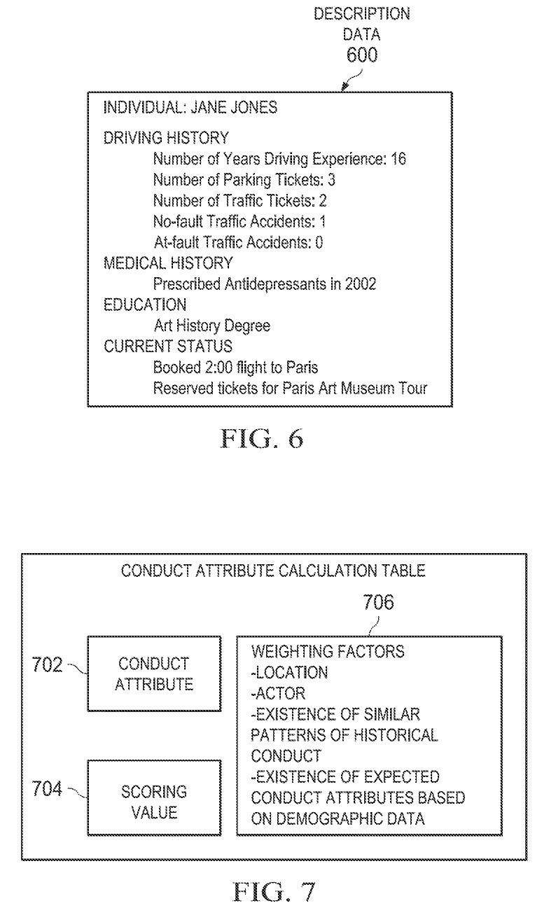

FIG. 6 is a block diagram of description data for an individual in accordance with an illustrative embodiment. Description data 600 is data comprising identification data, past history information, and current status information for an individual, such as description data 322 in FIG. 3. In this example, description data include the individual name, driving history, medical history, educational history, and current status information for a planned trip to France. The embodiments are not limited to this description data or this type of description data. The embodiments may be implemented with any type of pre-generated information describing events associated with the individual's current status and/or past history.

FIG. 7 is a block diagram of description data for an individual in accordance with an illustrative embodiment. Conduct attribute calculation table 700 is a conduct attribute calculation table such as conduct attribute calculation table 346 in FIG. 3. In addition, conduct attribute calculation table 700 is referenced by a cohort scoring engine, such as cohort scoring engine 342 in FIG. 3, for assigning values to each conduct attribute of a deportment and comportment cohort for calculating a deportment and comportment cohort score.

Conduct attribute 702 is an attribute describing a facial expression, body language, vocalization, social interaction, or other movement or motion by an individual that is an indicator of the appropriateness of the conduct of a member of a deportment and comportment cohort. A cohort scoring engine checks a look-up table or other data structure to identify scoring value 704 for each conduct attribute. The analysis server then aggregates the values for each conduct attribute to generate the deportment and comportment cohort score. In this example, but without limitation, the values assigned to each conduct attribute are assigned from a data structure storing at least one of conduct attribute values and weighting factors 706.

Weighting factors 706 is a set of one or more factors or circumstances that results in giving a particular conduct greater weight or lesser weight due to that circumstance. Weighting factors 706 enable calculation of an overall deportment and comportment cohort score for determining the appropriateness of a person's conduct in a given circumstance or situation. Circumstances may be identified through events metadata, such as events metadata 312 in FIG. 3. Examples of circumstances that affect the selection or calculation of weighting factor 706 include, for example, a location in which conduct attribute 702 is displayed, or the actors involved in the display of conduct attribute 702. In addition, the selection or calculation of weighting factor 706 may be based upon an existence of similar patterns of historical conduct, either by the actor, or by all actors exhibiting conduct attribute 702. Similarly, the selection or calculation of weighting factor 706 may be based upon an existence of expected conduct attributes based on demographic data. For example, younger children may be expected to wander aimlessly about, whereas middle aged people may be expected to have more direction and purpose in the manner of movement.

For example, if an adult is speaking in a raised voice, then a cohort scoring engine would locate the conduct attribute in conduct attribute scoring table 700 corresponding to speaking in a raised voice. Yelling may indicate that a person is angry, distracted, upset or violent. If an adult is yelling at a child to get out of the street because a car is coming, the weighting factor may indicate that such conduct is more appropriate than if a customer is yelling at a clerk in a bank. The circumstance in which the conduct occurs influences the weighting. Thus, conduct attribute values may also be weighted based on an identification of the actor, the location of the actor, behavior that is typical for the actor's demographic group under similar circumstances, and the actor's own past behavior. Higher or lower weighting factors may be assigned to each conduct attribute based upon the particular circumstance.

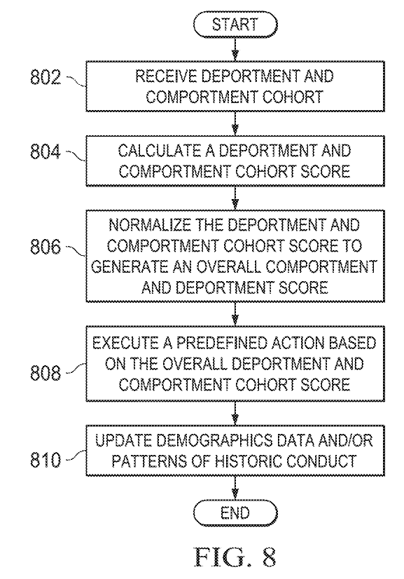

FIG. 8 is a flowchart of a process for scoring a deportment and comportment cohort in accordance with an illustrative embodiment. The process depicted in FIG. 8 may be implemented by a software component such as cohort scoring engine 342 in FIG. 3.

The process begins by identifying a deportment and comportment cohort (step 802). The deportment and comportment cohort is a deportment and comportment cohort such as deportment and comportment cohort 336 in FIG. 3. Thus, the deportment and comportment cohort include conduct attributes that describe facial expressions, body language, vocalizations, social interactions, and/or any other body movements that may be analyzed to determine appropriateness of an actor's actions.

The process calculates a deportment and comportment cohort score (step 804). The deportment and comportment cohort score may be calculated with reference to a conduct attribute calculation table, such as conduct attribute calculation table 700 in FIG. 7. The process then normalizes the deportment and comportment cohort score to generate an overall deportment and comportment score to generate an overall deportment and comportment cohort score (step 806). The process then executes a predefined action based on the overall deportment and comportment cohort score (step 808). In one embodiment, demographics data and/or patterns of historic conduct are updated (step 810) and the process terminates.

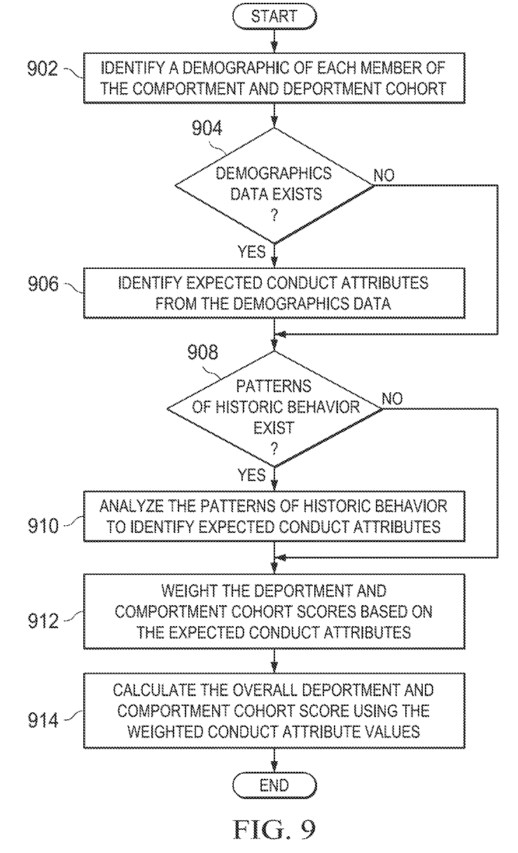

FIG. 9 is a flowchart of a process for normalizing a deportment and comportment cohort in accordance with an illustrative embodiment. The process may be implemented by a software component such as cohort scoring engine 342 in FIG. 3.

The process begins by identifying a demographic of each member of the deportment and comportment cohort (step 902). The process then makes the determination as to whether demographics data exists (step 904). If the process makes the determination that demographics data exists, then expected conduct attributes are identified from the demographics data (step 906).

The process makes the determination as to whether patterns of historic conduct exist (step 908). If the process makes the determination that patterns of historic conduct exist, then the process analyzes the pattern of historic conduct to identify expected conduct attributes (step 910).

The process then weights the deportment and comportment cohort scores based on the expected conduct attributes (step 912). The process then calculates the overall deportment and comportment cohort score using the weighted conduct attribute values. The process terminates thereafter.

Returning to step 904, if the process makes the determination that demographics data does not exist, then the process continues to step 908. Similarly, at step 908, if the process makes the determination that patterns of historic conduct do not exist, then the process continues to step 912.

Thus, according to one embodiment of the present invention, a computer implemented method, apparatus, and computer program product for scoring deportment and comportment cohorts. A deportment and comportment cohort having a set of conduct attributes is received. The conduct attributes may include at least one of a facial expression, vocalization, body language, and social interactions. A deportment and comportment cohort score is calculated. The deportment and comportment cohort score is normalized to calculate an overall deportment and comportment cohort score using at least one of demographic data and patterns of historical conduct. The overall cohort score indicates an appropriateness of conduct displayed by a member of the deportment and comportment cohort. Thereafter, a predefined action is executed based on the overall deportment and comportment cohort score.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

The invention can take the form of an entirely hardware embodiment, an entirely software embodiment or an embodiment containing both hardware and software elements. In a preferred embodiment, the invention is implemented in software, which includes but is not limited to firmware, resident software, microcode, etc.

Furthermore, the invention can take the form of a computer program product accessible from a computer-usable or computer-readable medium providing program code for use by or in connection with a computer or any instruction execution system. For the purposes of this description, a computer-usable or computer readable medium can be any tangible apparatus that can contain, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A computer implemented method for scoring a deportment and comportment cohort, the computer implemented method comprising:
responsive to receiving the deportment and comportment cohort, wherein the deportment and comportment cohort comprises a set of conduct attributes that describes at least one of a facial expression, vocalization, body language, and social interactions of a member in a set of members of the deportment and comportment cohort, calculating a deportment and comportment cohort score;
normalizing the deportment and comportment cohort score to calculate an overall deportment and comportment cohort score, wherein the deportment and comportment cohort score are normalized using at least one of demographic data and patterns of historical conduct, and wherein the overall cohort deportment and comportment score indicates an appropriateness of conduct displayed by a member of the deportment and comportment cohort; and
executing a predefined action based on the overall cohort score.

2. The computer implemented method of claim 1, wherein the predefined action comprises at least one of sending a warning, generating an alert, and dispatching security personnel.

3. The computer implemented method of claim 1, further comprising:
receiving events metadata, wherein the events metadata describes a set of circumstances associated with the set of members.

4. The computer implemented method of claim 1, wherein calculating the comportment score and the deportment score further comprises:
assigning a value to each conduct attribute from the set of conduct attributes, wherein the deportment and comportment cohort score is an aggregation of the values for each conduct attribute, and wherein the values for each conduct attribute are selected according to a set of circumstances associated with the set of members.

5. The computer implemented method of claim 1, wherein the overall deportment and comportment cohort score comprises a normalized comportment score and a normalized deportment score, and wherein the computer implemented method further comprises:
responsive to the normalized comportment score outside a range of specified comportment scores, executing a first predefined action; and
responsive to the normalized deportment score outside a range of specified deportment scores, executing a second predefined action.

6. The computer implemented method of claim 1, wherein normalizing the deportment and comportment score further comprises:
identifying a demographic of each member of the deportment and comportment cohort;
identifying expected conduct attributes from demographic data; and
weighting the deportment and comportment cohort score for conduct attributes for the member of the deportment and comportment cohort consistent with the expected conduct attributes defined by demographic data.

7. The computer implemented method of claim 1, wherein normalizing the deportment and comportment score further comprises:
analyzing patterns of expected behavior to identify expected conduct attributes; and
weighting the deportment and comportment cohort score for conduct attributes for each member of the deportment and comportment cohort consistent with the expected conduct attributes defined by patterns of expected behavior.

8. The computer implemented method of claim 1 further comprising:
updating at least one of the demographic data and the patterns of historical conduct with the conduct attributes of the deportment and comportment cohort.

9. A computer program product for scoring deportment and comportment cohorts, the computer program product comprising:
a computer recordable-type medium;
first program instructions for calculating a deportment and comportment cohort score in response to receiving the deportment and comportment cohort, wherein the deportment and comportment cohort comprises a set of conduct attributes that describes at least one of a facial expression, vocalization, body language, and social interactions of a member in a set of members of the deportment and comportment cohort;
second program instructions for normalizing the deportment and comportment cohort score to calculate an overall cohort deportment and comportment score, wherein the deportment and comportment cohort score are normalized using at least one of demographic data and patterns of historical conduct, and wherein the overall deportment and comportment cohort score indicates an appropriateness of conduct displayed by a member of the deportment and comportment cohort;
third program instructions for executing a predefined action based on the overall cohort score; and
wherein the first program instructions, the second program instructions, and the third program instructions are stored on the computer recordable-type medium.

10. The computer program product of claim 9 further comprising:
fourth program instructions for receiving events metadata, wherein the events metadata describes a set of circumstances associated with the set of members, and wherein the fourth program instructions are stored on the computer recordable-type medium.

11. The computer program product of claim 9 further comprising:
fifth program instructions for assigning a value to each conduct attribute from the set of conduct attributes, wherein the deportment and comportment cohort score is an aggregation of the values for each conduct attribute, wherein the values for each conduct attribute are selected according to a set of circumstances associated with the set of members, and wherein the fifth program instructions are stored on the computer recordable-type medium.

12. The computer program product of claim 9, wherein the second program instructions further comprise:
sixth program instructions for identifying a demographic of each member of the deportment and comportment cohort;
seventh program instructions for identifying expected conduct attributes from demographic data;
eighth program instructions for weighting the deportment and comportment cohort score for conduct attributes for the member of the deportment and comportment cohort consistent with the expected conduct attributes defined by demographic data; and
wherein the sixth program instructions, the seventh program instructions, and the eighth program instructions are stored on the computer recordable-type medium.

13. The computer program product of claim 9, wherein the second program instructions further comprise:
ninth program instructions for analyzing patterns of expected behavior to identify expected conduct attributes;
tenth program instructions for weighting the deportment and comportment cohort score for conduct attributes for each member of the deportment and comportment cohort consistent with the expected conduct attributes defined by patterns of expected behavior; and
wherein the ninth program instructions and the tenth program instructions are stored on the computer recordable-type medium.

14. The computer program product of claim 9, wherein the overall deportment and comportment cohort score comprises a normalized comportment score and a normalized deportment score, the computer program product further comprising:
eleventh program instructions for executing a first predefined action responsive to the normalized comportment score outside a range of selected comportment scores; and
twelfth program instructions for executing a second predefined action responsive to the normalized deportment score outside a range of deportment scores;
sive to the normalized deportment score outside a range of selected deportment scores; and
wherein the eleventh program instructions and the twelfth program instructions are stored on the computer recordable-type medium.

15. An apparatus for generating furtive glance cohorts, the apparatus comprising:
a bus system;
a memory connected to the bus system, wherein the memory includes computer usable program code; and
a processing unit connected to the bus system, wherein the processing unit calculates a deportment and comportment cohort score in response to receiving the deportment and comportment cohort, wherein the deportment and comportment cohort comprises a set of conduct attributes that describes at least one of a facial expression, vocalization, body language, and social interactions of a member in a set of members of the deportment and comportment cohort; normalizes the deportment and comportment cohort score to calculate an overall deportment and comportment cohort score, wherein the deportment and comportment cohort score are normalized using at least one of demographic data and patterns of historical conduct, and wherein the overall deportment and comportment cohort score indicates an appropriateness of conduct displayed by a member of the deportment and comportment cohort; and executes a predefined action based on the overall cohort score.

16. The apparatus of claim 15 wherein the processing unit further executes the computer usable program code to receive events metadata, wherein the events metadata describes a set of circumstances associated with the set of members.

17. The apparatus of claim 15 wherein the processing unit further executes the computer usable program code to assign a value to each conduct attribute from the set of conduct attributes, wherein the deportment and comportment cohort score is an aggregation of the values for each conduct attribute, wherein the values for each conduct attribute are selected according to a set of circumstances associated with the set of members.

18. The apparatus of claim 15, wherein the processing unit further executes the computer usable program code to identify a demographic of each member of the deportment and comportment cohort; identify expected conduct attributes from demographic data; and weight the deportment and comportment cohort score for conduct attributes for the member of the deportment and comportment cohort consistent with the expected conduct attributes defined by demographic data.

19. The apparatus of claim 15, wherein the processing unit further executes the computer usable program code to analyze patterns of expected behavior to identify expected conduct attributes; and weight the deportment and comportment cohort score for conduct attributes for each member of the deportment and comportment cohort consistent with the expected conduct attributes defined by patterns of expected behavior.

20. A system comprising:
a set of multimodal sensors, wherein the set of multimodal sensors generates multimodal sensor data associated with a set of individuals;
a cohort generation engine, wherein the cohort generation engine identifies a deportment and comportment cohort from multimodal sensor data, and wherein the deportment and comportment cohort comprises conduct attributes for the set of members that describes at least one of a facial expression, vocalization, body language, and social interactions of a member in the set of members; and
a cohort scoring engine, wherein the cohort scoring engine calculates a deportment and comportment cohort score in response to receiving the deportment and comportment cohort; normalizes the deportment and comportment cohort score to calculate an overall deportment and comportment cohort score, wherein the deportment and comportment cohort score are normalized using at least one of demographic data and patterns of historical conduct, and wherein the overall deportment and comportment cohort score indicates an appropriateness of conduct displayed by a member of the deportment and comportment cohort; and executes a predefined action based on the overall cohort score
